(19) United States
(12) Patent Application Publication
(10) Pub. No.: US 2007/0263795 A1
(43) Pub. Date: Nov. 15, 2007

(54) System and method for repeating an announcement that provides a new telephone number associated with a disconnected telephone number

(75) Inventor: Bourne Bao Li, Qingdao (CN)

Correspondence Address: HARNESS, DICKEY & PIERCE, P.L.C., P.O. BOX 8910, RESTON, VA, 20195, US

(73) Assignee: Lucent Technologies Inc.

(21) Appl. No.: 11/473,129

(22) Filed: Jun. 23, 2006

(30) Foreign Application Priority Data
Apr. 28, 2006 (CN) 200610077257.2

(51) Int. Cl. H04M 1/64

(52) U.S. Cl. 379/67.1

(57) ABSTRACT

A method for processing a telephone call that includes playing a message and replaying the message based on an input. The played message includes instructions for replaying the message, and the method replays the message if an input is received that corresponds with the instructions.

### PRIORITY STATEMENT

This non-provisional U.S. patent application claims priority under 35 U.S.C. § 119 to Chinese Patent Application No. 200610077257.2, filed on Apr. 28, 2006, the entire contents of which are incorporated herein by reference.

### BACKGROUND OF INVENTION

1. Field of the Invention

The present invention is related to a system and method for telecommunications. More particularly, the present invention relates to a system and method for repeating an announcement that provides a new telephone number associated with a disconnected telephone number.

2. Background Information

Establishing telephone contact with a party who has changed telephone numbers presents a variety of problems. In order for a caller to establish contact with such a party, the caller must obtain the person's new telephone number.

In conventional telephone communication systems, when a telephone company's subscriber changes telephone numbers, a party calling the subscriber at the old telephone number receives a message informing the calling party that the number has changed. The message also informs the calling party of the new telephone number of the subscriber. Conventionally, the message is played one time and the duration of the message is typically short. For example, the message may simply recite that “the number you dialed has been changed, and the new number is (111) 111-1111.” Typically, because of the short duration of the message and because the calling party is not expecting the telephone number to be disconnected, the calling party is generally unable to remember and/or record the new telephone number. Accordingly, the calling party must make a second call to obtain the new telephone number of the subscriber once the calling party has obtained a pen and paper for recording the new telephone number. The calling party must then make note of the new telephone number, hang up and dial the new telephone number.

Requiring the calling party to redial the disconnected number to record the new telephone number may be enough of an inconvenience to prevent the caller from attempting to contact the subscriber a second time. If the telephone company's subscriber is a business, the loss of potential callers, e.g., business customers, is highly undesirable.

Other systems such as directory assistance call completion are available to avoid a calling party having to redial the disconnected telephone number to retrieve the new telephone number. Directory assistance call completion is a system having logic residing within a switch for forwarding calls to a requested telephone number.

According to directory assistance call completion, a calling party calls directory assistance and provides information necessary to determine the telephone number of a destination party the calling party would like to contact. Directory assistance then provides the calling party with the destination party's telephone number and offers the option of completing the call to the destination for a fee, which is paid by the calling party. The calling party may then agree to pay the fee and have the call forwarded or simply make note of the destination party's telephone number, hang up and dial the destination party's telephone number. The directory assistance call completion service has the drawback that the service operates within the switch, consuming valuable switch system resources. Also, the calling party is generally charged a fee for the directory assistance service.

### SUMMARY OF THE INVENTION

One or more example embodiments of the present invention are directed towards a system and method for repeating an announcement that provides repeating an announcement that provides a new telephone number associated with a disconnected telephone number.

An example embodiment of the present invention provides a method of processing a telephone call that includes playing and replaying a message. The method plays a message, which includes instructions for repeating the message, if the telephone call is to a telephone number that has been disconnected, and replays the message if a received input corresponds with the instructions.

An example embodiment of the present invention provides a system for processing a telephone call. The system includes an intelligent processor playing a message if the telephone call is to a telephone number that has been disconnected and replaying the message based on an input. The message includes instructions for repeating the played message, and the intelligent processor replays the message if the input corresponds to the instructions.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus are not limiting of the present invention and wherein:

FIG. 1 is a block diagram of a telecommunications network architecture; and

FIG. 2 is a flow chart illustrating a method for repeating an announcement that provides a new telephone number associated with a disconnected telephone number according to an example embodiment of the present invention.

### DETAILED DESCRIPTION OF EXAMPLE EMBODIMENTS

Before describing an example embodiment of the present invention, key intelligent network elements will be described. Intelligent network components suitable for implementing example embodiments of the present invention are well-known in the art and commercially available.

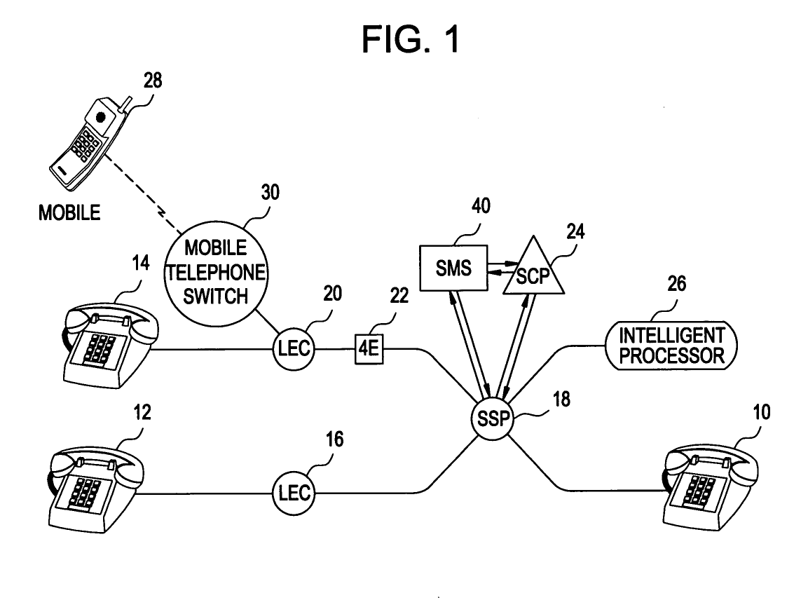

FIG. 1 is a block diagram of an example intelligent network architecture suitable for implementing a method for repeating an announcement that provides a new telephone number associated with a disconnected telephone number according to an example embodiment of the present invention.

The intelligent network architecture has a modular configuration of network elements to provide enhanced telecommunications services. Switching functions are performed by the base network in a conventional manner. The intelligent network architecture in FIG. 1 includes a service switching point (SSP) 18, a service control point (SCP) 24, and a service management system (SMS) 40. The intelligent network also includes an intelligent processor (IP) 26. One skilled in the art will appreciate that the intelligent network elements could be owned or controlled by a local exchange carrier (LEC), an interexchange carrier (not shown), a competitive access provider (not shown), or some combination of the three.

The SSP 18 is a switch that recognizes service requests, requests call handling instructions from the SCP 24, and executes the call handling instructions to complete a telephone call, forwarding procedure, and/or messaging procedure. The SSP 18 provides intelligent network “triggering”.

Triggering is the process by which the SSP 18 determines that a query message requesting call handling instructions should be sent to the SCP 24. A trigger is an occurrence of an event and/or the satisfaction of certain conditions which result in a message to the SCP 24. Triggers can be originating triggers, mid-call triggers, or terminating triggers. Examples of originating triggers are off-hook immediate, offhook delay triggers, and custom dialing plan triggers. An example of a mid-call trigger is the busy condition. An example of a terminating trigger is the ring-no answer condition. According to an example embodiment of the present invention as described below, a trigger is generated whenever a dialed telephone number matches one of the telephone numbers included in a list of changed telephone numbers.

Further, the SSP 18 also formulates and transmits requests to the SCP 24 and processes replies and requests from the SCP 24. The SSP 18 creates and plays intelligent network announcements formulated by the service provider (e.g., a local exchange or inter-exchange carrier), and transmits event messages (e.g., busy or no reply signals) to the SCP 24. For example, the SSP 18 may play an announcement indicating a dialed telephone number has been changed and providing a new telephone number.

It should be noted that the SSP 18 is capable of functions other than those mentioned above, such as processing billing records for a call. However, these “other functions” are beyond the scope of this invention, and therefore will not be described in detail herein.

The SCP 24 is an intelligent network element that stores call control and call routing instructions to be executed by the SSP 18. The SCP 24 receives and processes event messages received from the SSP 18, and formulates and sends responses to the SSP 18. In addition, the SCP 24 processes accounting and statistical information, such as the time of day and day of the week of the call and various other call parameters. The SCP 24 interfaces with and receives commands for controlling services and service features from the SMS 40.

It should be noted that communications between the SSP 18 and SCP 24 may be carried out over a Common Channel Signaling (CCS) network. CCS networks are well known in the art of telecommunications, and are generally used to communicate call control information among network elements. The CSS networks typically employ packet switching techniques to accomplish this task. The packet switches used in CCS networks are commonly referred to as Signal Transfer Points (STPs).

The SMS 40 is a management and provisioning system that serves as an intelligent network service administration platform. The SMS 40 formulates and sends commands to the SCP 24 to control services and service features.

The IP 26 provides specialized functionality, such as speech recognition (identifying spoken words) and voice recognition (recognizing the voice of a particular speaker) capability. The IP 26 may also perform the functions of a video signal generator or video signal database for applications such as providing images for use in a video telephone call forwarding service. The functionality of the IP 26 may be implemented in a separate network element, or may be implemented through a multimedia SCP. Other examples of services that may be offered through the IP 26 include message recording, message playing, message erasing, voice digit dialing, and name dialing. Intelligent processor equipment suitable for use with example embodiments of the present invention are well known in the art of intelligent network systems.

It is noted that there are many well known ways to couple telephone calls between telephone stations. Examples of such coupling, all of which are suitable for use in the present invention, are: standard telephone lines, twisted shielded pair lines, coaxial cables, fiber optic lines, and wireless links. It should also be noted that various types of “calls” and various types of “telephone stations” fall within the scope of the invention. For example, a “call” may take the form of a data transmission from a computer or a fax transmission from a facsimile machine. Moreover, “telephone stations” to which calls are forwarded may include dedicated answering machines, such as a voice mailbox.

Further, as shown in FIG. 1, calls may be routed to the SSP 18 in a variety of ways. For example, a call placed from a mobile phone 28 is routed to SSP 18 through a mobile telephone switch 30, a LEC switch 20 and a 4E switch 22. As another example, a call placed from telephone station 12 and is routed directly to SSP 18 through a LEC switch 16.

For purposes of illustration, assume that a subscriber has changed telephone numbers from an old telephone number (222) 222-2222 to a new telephone number (333) 333-3333 associated with telephone station 10. Further, assume a calling party using a telephone station 14 attempts to contact the subscriber using the old telephone number (222) 222-2222. Accordingly, the calling party dials the subscriber's old telephone number (222) 222-2222 using telephone station 14. This call is routed to the SSP 18 through a LEC switch 20 and a 4E switch 22.

The SSP 18 may process the received call using a variety of different techniques.

For example, a call directed to a subscriber's old telephone number (222) 222-2222 from the telephone station 14 may be rerouted to telephone station 10 associated with the subscriber's new telephone number (333) 333-3333. This rerouting is performed in response to a trigger. A trigger is generated when the SSP 18 recognizes a dialed number to be an old telephone number (i.e. a number that has been changed). To enable this type of triggering a list of changed numbers is stored in the SSP 18. The list of changed numbers is supplied and maintained by a network operator.

If the SSP 18 detects a match between the dialed number (222) 222-2222 and a number in the list, a trigger is generated. In response to the trigger, the SSP formulates a query that includes the dialed number (222) 222-2222 and sends the query to the SCP 24.

The SCP 24 includes a database containing service data for each subscriber. The data is subdivided into subscriber records with each subscriber record including the subscriber's old telephone number (222) 222-2222 and a subscriber specified forwarding number (333) 333-3333. Upon receiving the query from the SSP 18, the SCP 24 cross-references the dialed number (222) 222-2222 with the database entry for the called subscriber, retrieves the forwarding number (333) 333-3333 (i.e. the number of telephone station 10) from the subscriber's record, and passes the forwarding number to the SSP 18. The SSP 18 receives the forwarding number and uses it to route the call to telephone station 10.

The SSP 18 may also process the received call using a messaging procedure. The same assumptions that a subscriber has changed telephone numbers from an old telephone number (222) 222-2222 to a new telephone number (333) 333-3333 associated with telephone station 10, and that a calling party using a telephone station 14 has dialed the old telephone number (222) 222-2222 are used to explain the messaging procedure.

Again, the call from telephone station 14 is coupled to SSP 18 through the LEC switch 20 and the 4E switch 22. The SSP 18 compares the dialed number (222) 222-2222 to a list of changed telephone numbers. The SSP 18 generates a trigger if the dialed telephone number matches one of the telephone numbers in the list. In response to the trigger, the SSP 18 formulates a query that includes the dialed number (222) 222-2222 and sends the query to the SCP 24. The SCP 24 cross-references the dialed number (222) 222-2222 to a subscriber record and retrieves the record. However, unlike the record described above with respect to the call forwarding procedure, the record in the messaging procedure will indicate that the messaging procedure should be used.

There are many types of messaging procedures, which may be implemented. For example, after retrieving the subscriber's record, the SCP 24 instructs the SSP 18 to couple the call to an IP 26. The IP 26 plays a voice message to the calling party that informs the calling party that the dialed telephone number (222) 222-2222 has been changed and that the subscriber's new telephone number is (333) 333-3333.

According to an example embodiment of the present invention, the IP 26 then provides the calling party with an option to replay the voice message.

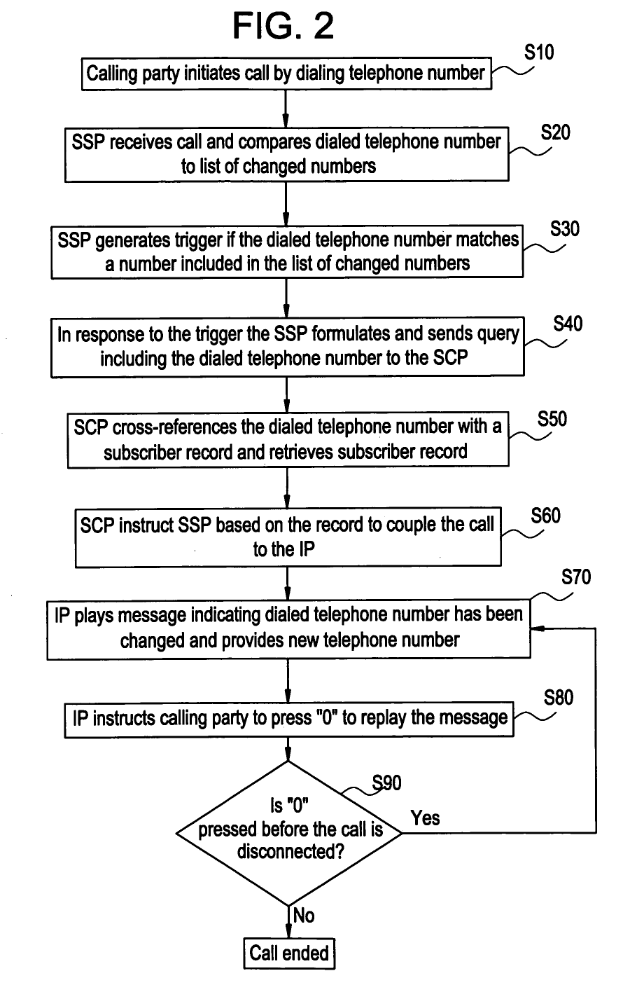

FIG. 2 is a flow chart illustrating a method for repeating an announcement that provides a new telephone number associated with a disconnected telephone number according to an example embodiment of the present invention.

In step S10 of FIG. 2, the calling party initiates a call using telephone station 14 by dialing the old telephone number (222) 222-2222. The call from telephone station 14 is coupled to SSP 18 through LEC switch 20 and 4E switch 22. In step S20 of FIG. 2, the SSP 18 compares the dialed number (222) 222-2222 to a list of changed telephone numbers. The SSP 18 finds a match in the list of changed numbers because the subscriber previously associated with the dialed number (222) 222-2222 is now associated with the new telephone number (333) 333-3333. However, if a match was not found, the call would be completed as is well-known in the art, and thus will not be discussed herein for the sake of brevity.

In step S30 of FIG. 2, the SSP 18 generates a trigger because the dialed number matches one of the telephone numbers in the list

In response to the trigger, the SSP 18 formulates a query that includes the dialed number (222) 222-2222 and sends the query to the SCP 24 in step S40. The SCP 24 cross-references the dialed number (222) 222-2222 to a subscriber record and retrieves the record in step S50. The record indicates that a messaging procedure should be used. Accordingly, after retrieving the subscriber's record, the SCP 24 instructs the SSP 18 to couple the call to the IP 26 in step S60. The IP 26 plays a voice message to the calling party that informs the calling party that the dialed telephone number (222) 222-2222 has been changed and the subscriber's new telephone number is (333) 333-3333 in step S70.

An example embodiment of the present invention enables the user to repeat the played message as detailed below. In step S80 of FIG. 2, the IP 26 instructs the user to press “0” to replay the message. Accordingly, if the calling party did not have a pen and paper for recording the new telephone number (333) 333-3333, the user may obtain a pen and paper and request that the message be played again by pressing, for example, “0”. As such, the user is not forced to redial the old telephone number again to obtain the new telephone number.

As illustrated by step S90 of FIG. 2, after instructing the user to press “0” to replay the message, the IP 26 waits an amount of time for input from the calling party. This amount of time may vary and may be set by a network operator. If the amount of time expires before the IP 26 detects an input from the calling party, the call may be disconnected. Conversely, if the IP 26 detects user input of “0”, the message is replayed. The IP 26 may detect an input by the calling party based on Dual Tone Multi Frequency Signaling (DTMF) as is well known in the art.

Example embodiments of the present invention being thus described, it will be obvious that the same may be varied in many ways. Such variations are not to be regarded as a departure from the invention, and all such modifications are intended to be included within the scope of the invention. For example, the user may be instructed to press another key instead of “0” to replay the message. Still further, additional options may be provided to the user in addition to repeating the message indicating the dialed telephone number has changed and providing the new telephone number.

What is claimed:

1. A method of processing a telephone call comprising:
playing a message if the telephone call is to a telephone number that has been disconnected, the message including instructions for repeating the played message; and
replaying the message based on an input received that corresponds with the instructions.

2. The method of claim 1, further comprising:
receiving the telephone call;
comparing the disconnected telephone number to a list of changed numbers, wherein
the playing step plays the message based on the comparing step.

3. The method of claim 2, wherein the message includes a new telephone number associated with the disconnected telephone number.

4. The method of claim 3, wherein the comparing step comprises:
generating a trigger if there is a match for the disconnected telephone number in the list of changed numbers;
formulating a query including the disconnected telephone number based on the generating step; and
obtaining a record based on the formulating step that includes the new telephone number, wherein
the playing step plays the message including the new telephone number based on the obtaining step.

5. The method of claim 1, wherein the instructions instruct a caller to press a key to replay the message.

6. The method of claim 1, further comprising:
waiting an amount of time for the input; and
disconnecting the telephone call if the input is not received within the amount of time.

7. A system for processing a telephone call comprising:
an intelligent processor playing a message if the telephone call is to a telephone number that has been disconnected, the message includes instructions for repeating the played message, and replaying the message based on an input received that corresponds with the instructions.

8. The system of claim 7, further comprising:
a service switching point (SSP) storing a list of changed telephone numbers, receiving the telephone call, comparing the telephone number with the list of changed telephone numbers, and formulating and transmitting a query including the telephone number based on the comparison of the telephone number with the list of changed numbers; and
a service control point (SCP) receiving the query, obtaining a record based on the query and instructing the SSP based on the record to couple the telephone call to the intelligent processor.

9. The system of claim 7, wherein the instructions instruct a caller to press a key to replay the message.

10. The system of claim 7, wherein the intelligent processor waits an amount of time for the input and disconnects the telephone call if the input is not received within the amount of time.
